(19) United States
(12) Patent Application Publication
(10) Pub. No.: US 2025/0084751 A1
(43) Pub. Date: Mar. 13, 2025

(54) ARTIFICIAL INTELLIGENCE GENERATED SYNTHETIC SENSOR DATA FOR DRILLING

(71) Applicant: Schlumberger Technology Corporation, Sugar Land, TX (US)

(72) Inventors: Carlos Urdaneta, Houston, TX (US); Cheolkyun Jeong, Katy, TX (US); Shunfeng Zheng, Katy, TX (US)

(21) Appl. No.: 18/827,082

(22) Filed: Sep. 6, 2024

Related U.S. Application Data
(60) Provisional application No. 63/581,290, filed on Sep. 8, 2023.

(51) Int. Cl. E21B 44/00; E21B 21/08; G06N 20/00

(52) U.S. Cl. CPC E21B 44/00; E21B 21/08; G06N 20/00; E21B 2200/20

(57) ABSTRACT

A method for generating synthetic sensor data during a drill operation includes training an artificial intelligence based backup sensor model, deploying the trained backup sensor model at a drilling location, and evaluating sensor data acquired from a plurality of sensors while drilling with the trained backup sensor model to synthesize backup sensor data.

### CROSS REFERENCE TO RELATED APPLICATIONS

This application claims priority to U.S. Provisional Patent Application No. 63/581,290, which was filed on Sep. 8, 2023 and is incorporated herein by reference in its entirety.

### BACKGROUND

The downhole drilling environment is severe. Downhole tools are routinely subject to conditions in which the temperature may exceed 200 degrees C. and the hydrostatic pressure may exceed 10,000 psi. Much higher temperatures are sometimes encountered in geothermal drilling operations. Moreover downhole tools are routinely subject to severe shocks and vibrations while drilling. For example, a downhole tool may be subject to axial vibrations caused by bit bounce, torsional vibrations caused by stick slip, and lateral vibrations caused by whirl. During backwards and chaotic whirl, a downhole tool may repeatedly strike the borehole wall with great force.

Modern downhole tools commonly include numerous electronic sensors. For example, rotary steerable (RSS) tools, measurement while drilling (MWD) tools, and logging while drilling (LWD) tools may include dozens of electronic sensors. It will be appreciated that the above-described severe drilling conditions, particularly the extreme temperatures, shocks, and vibrations can lead to sensor failures. Such sensor failure can sometimes lead to tool malfunction or may even jeopardize the objectives of the drilling operation such that the drill string must be pulled out of the hole and the damaged tool replaced. As is well known in the industry, tripping the drill string out of the wellbore to replace a damaged downhole tool is both time-consuming and expensive, particularly in a deep wellbore.

Downhole sensors are generally configured to be robust to the severe drilling environment. Moreover, downhole tools may sometimes include redundant sensor deployments for certain critical measurements. While the use of robust sensor configurations and redundant sensors may reduce the number of critical sensor failures, such failures remain problematic, particularly when extreme temperatures or extreme shocks and vibrations are encountered. There is a need in the industry to improve the reliability of downhole sensors and sensor measurements, for example, in MWD tools.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including an example system for generating synthetic sensor data.

FIG. 2 depicts a flowchart of one example method for synthesizing downhole sensor data during a drilling operation.

FIG. 3 depicts a flowchart of one example method for generating a backup sensor model.

FIG. 4 depicts a flowchart of one example method for tuning or optimizing a deployed backup sensor model and synthesizing backup sensor data.

FIG. 5 depicts a flow chart of one example method for evaluating synthesized backup sensor measurements for use in a drilling operation.

FIG. 6 depicts a scatter plot of synthesized (predicted) internal pipe pressure measurements using a backup sensor model and actual internal pipe pressure measurements obtained during model verification.

### DETAILED DESCRIPTION

Embodiments of this disclosure include systems and methods for generating synthetic sensor data while drilling. One example method includes training a deep learning model with historical drilling data to obtain a trained backup sensor model; deploying the trained backup sensor model at a drilling location; acquiring sensor measurements from a plurality of sensors while drilling the subterranean wellbore; and synthesizing backup sensor measurements for at least one other sensor using the acquired sensor measurements and the trained backup sensor model.

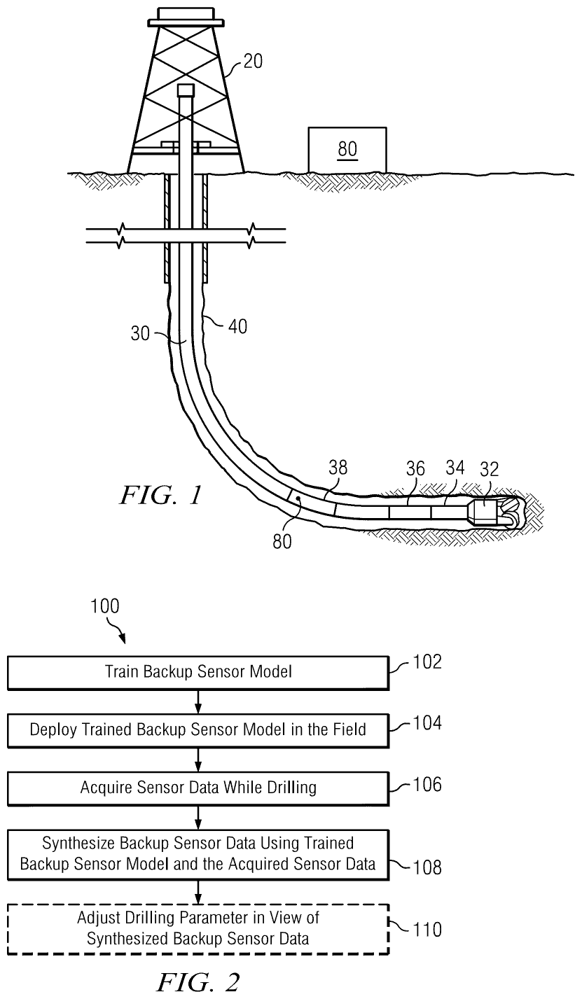

FIG. 1 depicts an example drilling rig 20 including a system 80 for generating synthetic sensor data while drilling. The drilling rig 20 may be positioned over a subterranean formation (not shown) and may be configured for drilling a geothermal well or a hydrocarbon exploration and/or production well. The rig 20 may include, for example, a derrick and a hoisting apparatus (also not shown) for raising and lowering a drill string 30, which, as shown, extends into wellbore 40 and includes, for example, a drill bit 32, a steering tool 34 (such as a rotary steerable tool), a logging while drilling (LWD) tool 36, and a measurement while drilling (MWD) tool 38. In this type of system, the wellbore 40 may be formed in the subsurface formations by rotary drilling in a manner that is well-known to those or ordinary skill in the art (e.g., via known directional drilling techniques). Those of ordinary skill in the art given the benefit of this disclosure will appreciate, however, that the present invention also finds application in drilling applications other than conventional rotary drilling (e.g., mud-motor based directional drilling), and is not limited to land-based rigs.

As is known to those of ordinary skill, the drill string 30 may be rotated, for example, at the surface to drill the well (e.g., via a rotary table). A pump may deliver drilling fluid to the interior of the drill string 30 thereby causing the drilling fluid to flow downwardly through the drill string 30. The drilling fluid exits the drill string 30, e.g., via ports in a drill bit 32, and then circulates upwardly through the annular region between the outside of the drill string 30 and the wall of the wellbore 40. In this known manner, the drilling fluid lubricates the drill bit 32 and carries formation cuttings up to the surface.

Various sensors are located about the wellsite to collect data related to the drilling operation, such as standpipe pressure, pump pressure, hook load, wellbore depth, surface torque, rotary rpm, among others. The drill string may also include numerous downhole sensors disposed in the drill bit 32, the steering tool 34, the LWD tool 36, and the MWD tool 38, to provide information about downhole conditions, such as wellbore pressure, weight on bit, torque on bit, wellbore heading or attitude (inclination and azimuth), collar rpm, tool temperature, annular temperature, and toolface, among others. These sensors (deployed uphole and/or downhole) may be configured to provide data to the system 80 for synthesizing sensor data.

Downhole tools, such as steering tool 34, LWD tool 36, and MWD tool 38, commonly include numerous sensors. Such sensors may include sensors for measuring borehole and formation conditions, for example, including microelectricalmechanical systems (MEMS) sensors for measuring temperature and pressure at various locations in the string, strain gauges and load cells for measuring weight on bit (WOB), torque on bit (TOB), and shock, survey sensors such as accelerometers, magnetometers, and gyroscopes for measuring the attitude of the wellbore and the toolface angle of the tool in the wellbore, and motion sensors such as accelerometers and magnetometers, for measuring, the rotation rate of the drill string as well as shock and vibration accelerations. Downhole tools commonly further include numerous logging sensors such as gamma ray (GR) sensors, electromagnetic (EM) sensors, resistivity sensors, acoustic and ultrasonic transducers, and the like. Downhole tools may further include a number of system sensors, for example, including voltage and power sensors for measuring the performance of power supplies, motors, solenoids, and other electronics. It will be appreciated that the above listing of sensors is not intended to be exhaustive, but is merely representative of the many example sensors found in downhole tools.

It will be appreciated that the disclosed embodiments may also be employed in coiled tubing (CT) drilling operations in which the drill bit and bottom hole assembly (BHA) are conveyed into the wellbore via a continuous length of coiled tubing (rather than a drill string). In such CT operations, a mud motor or turbine is commonly employed to rotate the drill bit since the coiled tubing is not rotated in the wellbore. A CT BHA commonly includes various downhole measurement tools and sensors as well as a downhole steering tool or bent sub configured for controlling the direction or the rate of change of the direction of drilling. For example, many CT operations employ underbalanced or managed pressure drilling and make use of numerous pressure sensors and other corresponding sensors in the BHA. In CT operations, the downhole sensor measurements are commonly transmitted to the surface via a wireline or wireless telemetry link (although the disclosed embodiments are not limited in this regard).

With continued reference to FIG. 1, in example embodiments, the system 80 may be deployed at the rig site (e.g., in an onsite laboratory as depicted) or offsite. Moreover, the system 80 may also (alternatively and/or additionally) be deployed in the drill string, for example, in an MWD tool 38 as depicted. The disclosed embodiments are, of course, not limited in this regard. The system 80 may include computer hardware and software configured to automatically or semi-automatically receive and evaluate sensor data from a large number of uphole and/or downhole sensors with a trained model to synthesize (predict) sensor data for at least one downhole sensor (e.g., a pressure sensor or a strain gauge). To perform these functions, the hardware may include one or more processors (e.g., microprocessors) which may be connected to one or more data storage devices (e.g., hard drives or solid state memory). As is known to those of ordinary skill, the processors may be further connected to a network, e.g., to receive the various sensor data from networked sensors) or another computer system. The system 80 may be further configured to receive a trained machine learning model. It will be further understood that the disclosed embodiments may include processor executable instructions stored in the data storage device. The executable instructions may be configured, for example, to execute methods 100, 120, 140, and 160 to synthesize the sensor data and make use of the synthesized sensor data as described in more detail below. It will, of course, be understood that the disclosed embodiments are not limited to the use of or the configuration of any particular computer hardware and/or software.

FIG. 2 depicts a flowchart of one example method 100 for synthesizing downhole sensor data during a drilling operation. Method 100 includes training a deep learning (artificial intelligence based) model with historical drilling data at 102 to obtain a trained backup sensor model. The historical drilling data may include, for example, time- or depth-series sensor data from a number of previously drilled wells. As described in more detail below, the training may include identifying relationships and/or correlations between the data from various sensors in the historical drilling data. The trained model may be deployed in the field (e.g., at a drilling location or an oil field) at 104 where it may be utilized during a drilling operation. The trained model may be deployed, for example, in a downhole tool such as an MWD tool, an LWD tool, or a steering tool. The trained model may alternatively and/or additionally be deployed in a surface computer system located at a rig site.

Sensor data may be acquired while drilling a wellbore in the field at 106 and evaluated using the deployed backup sensor model at 108 to synthesize (or predict) sensor data for at least one downhole sensor. In downhole deployments, the sensor data may be received directly from the downhole sensors. In uphole deployments, the sensor data may be received via a telemetry link (e.g., a mud pulse or mud siren telemetry link or a coiled tubing wireline telemetry link) that transmits the data to the surface. Method 100 may further optionally include adjusting one or more drilling parameters at 110 in response to the synthesized sensor data. For example, the adjusted drilling parameters may be one or more of a rotary table speed, a pump pressure, a drilling fluid flow rate, and a hook load (or WOB). In one example embodiment, the pump pressure or drilling fluid flow rate may be adjusted in view of the synthesized pressure sensor data.

With continued reference to FIG. 2, the downhole sensor for which the sensor data is modelled and synthesized may include substantially any suitable downhole sensor, for example, including an MWD sensor, an LWD sensor, or a RSS tool sensor. MWD sensors may include, for example, strain gauges, pressure sensors, temperature sensors, accelerometers, magnetometers, ultrasonic sensors, and the like configured, for example, to measure torque on bit (TOB), weight on bit (WOB), internal and external (annular) pressures, shocks, vibrations and vibrational frequencies, inclination, azimuth, toolface angle, standoff distance, and/or borehole caliper. LWD sensors may include, for example, resistivity sensors including high and low frequency electromagnetic antennas configured to measure attenuation and phase difference as well as galvanic button electrodes, porosity sensors, density sensors, gamma ray sensors, photoelectric effect sensors, sonic and ultrasonic transducers, and nuclear magnetic resonance sensors. RSS sensors may include, for example, the above listed MWD sensors as well as sensors configured to monitor the steering actuation mechanism, such a pad displacement sensors.

It will be appreciated that the disclosed embodiments further may include a downhole tool or a system. The system may include a downhole tool, such as an MWD tool, an LWD tool, or a steering tool, having a plurality of sensors and one or more modelled backup sensors. By modelled backup sensor it is meant a backup sensor for which the backup sensor measurements are generated by the trained deep learning model. The deep learning model is trained to predict (or synthesize) the backup sensor measurements based on other sensor measurements (e.g., other sensor measurements made in the downhole tool and/or other sensor measurements made by other downhole tools or made at the surface).

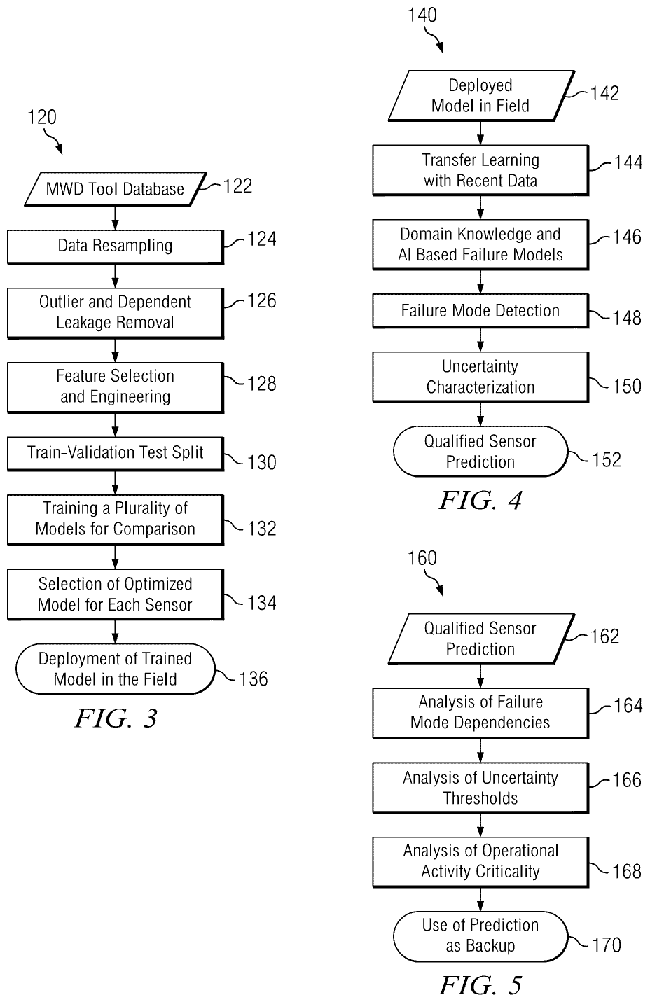

FIG. 3 depicts a flowchart of one example method 120 for generating a trained backup sensor model. The method includes acquiring a database of sensor data from historical drilling operations at 122 (e.g., from a data library including tens, hundreds, or even thousands of wells). The sensor data may include sensor data from a number of downhole tools, for example including a steering tool, an MWD tool, and/or an LWD tool. The sensor data may also include data from various surface sensors. The acquired data may be pre-processed at 124, for example, to clean, normalize, format, and fill in missing data from within the received drilling data. The pre-processing at 124 may further include rescaling the data in time (or synchronizing the data from the different sensors), for example, via computing moving averages, data resampling, or time sampling. The data may be further pre-processed, or example, via filtration to remove statistical outliers or other outlying data points at 126 (e.g., via an interquartile range methodology). The pre-processing at 126 may further include removing or combining related data channels. For example, sensor measurements from a power supply that provides power to a pressure sensor may be removed from consideration when generating a backup model for the pressure sensor.

The pre-processed data may be evaluated at 128, for example, to select the data channels (the other sensor measurements) that are most relevant to each backup sensor model. For example, relevant channel inputs may surface measurements, such as rate of penetration, hook load, depth, circulating pressure, wellhead pressure, drilling fluid flow rate, total fluid volume, nitrogen rate (e.g., in a CT operation) and other downhole measurements, such as weight on bit, torque on bit, differential pressure, vibrational amplitude and frequency, temperature, as well as any other MWD, RSS, and LWD measurements when available.

Variable importance analysis may be used to interpret the sensor extraction mechanisms. Moreover, various correlations may be developed between the many sensor channels. For example, when the backup sensor model is for an internal pressure sensor, relevant sensor channels may include other pressure sensor measurements including pressure sensors on other tools in the string, annular pressure sensor measurements, WOB sensor measurements, axial vibration sensor measurements, and downhole temperature measurements.

The selection at 128 may further include generating linear or nonlinear (e.g., polynomial) combinations of particular sensor measurements. In the above example in which the backup sensor model is configured for an internal pressure sensor, example combinations may include one or more of the following: (i) a sum of an annular pressure sensor measurement and a WOB measurement, (ii) a sum of an x-, y-, or z-axis vibration amplitude measurement and an annular pressure sensor measurement, (iii) the sum of a downhole temperature measurement and an annular pressure sensor measurement, and (iv) a difference between an annular temperature measurement and an internal temperature measurement. The disclosed embodiments are, of course, not limited in these regards.

The pre-processed data may then be used to train and validate the backup sensor models at 130 and 132. For example, the historical data may be split into a training subset and a validation subset at 130 and then used to train the deep learning models at 132. As noted above, the training may include identifying relationships and/or correlations between the data obtained from the different sensor channels (e.g., between one sensor and another sensor or combinations of other sensors). The training and validation may further include tuning model hyper parameters and optimizing to achieve the lowest mean absolute percentage error (MAPE). The training may make use of customized deep learning architectures suitable for regression and may further compare and contrast the predictive performance of many different artificial intelligence (AI) based regression methods including, for example, linear and nonlinear regression, decision trees, gradient boosting (e.g., gradient boosted trees), extra trees, random forest, neural networks, feed forward neural networks, recurrent neural networks, convolutional neural networks, transformer networks, variational autoencoders, generated adversarial networks, as well as an ensemble of the best performing models to define which is the best performing architecture for a particular sensor at 134. In certain example implementations, ensemble methods including random forest and extra trees may provide superior performance. The trained model may be deployed in the field (e.g., at a wellsite) at 136.

With continued reference to FIG. 3, an optimized model may be selected for each of the backup sensor models at 134 (e.g., for each of the sensors for which a backup sensor model is trained). The optimized model may be deployed in the field at 136, for example, in a surface computer system or within the controller of a downhole tool (e.g., an MWD controller or LWD controller) as described above with respect to element 80 of FIG. 1. It will be appreciated that the optimal deployment of the backup sensor model may depend on the operational objectives of the drilling operation as well as the particular backup sensor. For example, surface deployment may advantageously enable the backup sensor model to make use of both surface sensor measurements and downhole tool sensor measurements which may provide a more robust suite of sensor measurements for use in synthesizing the backup sensor measurements. However, downhole deployment of the backup sensor model may enable the model to make use of higher frequency data sets (since there is no need to transmit the data to the surface via a bandwidth limited channel such as mud pulse or mud siren telemetry). Moreover, the disclosed embodiments may be particularly advantageous for use in CT operations in which sensor data is transmitted to the surface via a wireline telemetry link. The disclosed embodiments are expressly not limited to either downhole or surface deployment of the backup sensor model. In certain example embodiments the backup sensor model may be deployed both uphole and downhole.

Turning now to FIG. 4 a flowchart of one example iterative method 140 for tuning or optimizing a deployed backup sensor model and synthesizing backup sensor data in the event of a sensor failure is depicted. The method 140 includes deploying a trained backup sensor model in the field at 142, for example, as described above with respect to FIGS. 2 and 3. Recent data from the same field as the deployment, and/or from the same wellbore (such as from different laterals) is acquired at 144, for example, as the data becomes available. The field data is further evaluated at 144 to retrain or fine tune the deployed model, for example, to identify or modify the relationships and/or correlations between various sensor measurements. This retraining may advantageously improve the accuracy of the deployed model by emphasizing local (field) characteristics and sensor measurements.

With continued reference to FIG. 4, the retrained model may evaluate incoming sensor data to identify possible sensor failures. It will be appreciated that the error margin for each sensor channel may be affected by the particular sensors that fail or by the extent of the sensor failures (if multiple sensors fail). As a result, sensor failure detection may be accomplished at 146 based on a combination of predefined domain knowledge thresholds and AI based models to determine which sensor(s) have failed. The failure modes detected at 148 may be used to calculate/predict a degree of uncertainty at 150 of the corresponding synthesized backup sensor data. The resulting prediction may be qualified with its uncertainty at 152 and then provided to a drilling engineer. This process may be iterative as indicated to provide the most up to date tuning of the deployed backup sensor model and to continuously provide synthesized backup sensor data in the event of a sensor failure.

FIG. 5 depicts a flow chart of one example method 160 for evaluating synthesized backup sensor measurements (e.g., evaluating whether the synthesized measurements have sufficient accuracy or robustness to be used in the drilling operation). A qualified sensor prediction is received at 162 (e.g., by a drilling engineer). The qualified sensor prediction may include, for example, the synthesized sensor measurements (such as synthesized pressure sensor measurements) as well as additional data to assist the driller. The additional data may include, for example, a description of the failed sensor or sensors as well as a statistical characterization of the uncertainty inherent in the synthesized measurements. The additional data may further include a listing of the most relevant other sensors or sensor combinations used to synthesize the measurements.

The method 160 may optionally make use of an automated software system to evaluate the received sensor prediction. The analysis may first consider how many failure modes have been detected at 164, as there may be more than one failed sensor (it will be appreciated that severe shocks and vibrations can cause multiple simultaneous sensor failures). The analysis may consider how close the error margin is to pre-established thresholds of acceptability at 166. For example, the received uncertainty may be compared with the known uncertainty inherent in the failed sensor (prior to failure). Furthermore, the analysis may consider the criticality of the failed sensor and the criticality of the failed sensor data to the operational objectives at 168. A decision may then be made whether or not it is acceptable to use the synthesized sensor data as a backup. It will be appreciated that the synthesized sensor data may be more readily used at 170 when there are a small number sensor failures, uncertainty is low, or a failed sensor is not highly critical to the operational objectives.

The disclosed embodiments are described in more detail by way of the following non-limiting proof of concept experiments. In a first example implementation, backup sensor data was synthesized for an internal pipe pressure sensor deployed in an MWD tool. An ensemble of multiple deep learning models was trained using data acquired from approximately 500 runs (drilled sections of a wellbore). Model training and verification (in which 80% of the data was used for training and 20% of the data was used for verification) resulted in a backup sensor model (a regressor) having a MAPE of 34.1%. In this particular example, the most relevant sensor channels included linear combinations of annular pressure, WOB (uncompensated), and triaxial vibration (acceleration).

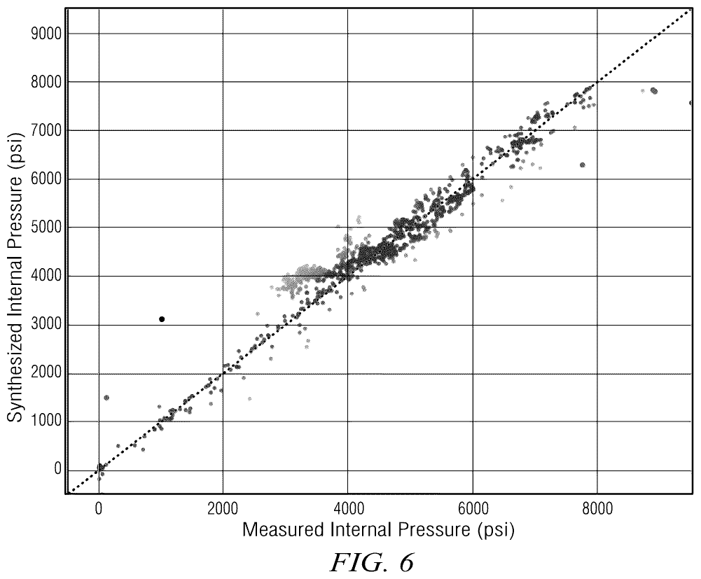

FIG. 6 depicts a scatter plot of the synthesized (predicted) internal pipe pressure measurements and the actual internal pipe pressure measurements obtained in the model verification. The dotted line is the line at which the synthesized measurements are equal to the actual measurements. Note the good fit between the synthesized and actual measurements obtained during verification. Depending on the operational objections, such accuracy (low uncertainty) may be acceptable for continued use in a drilling operation and may advantageously obviate the need to pull the drill string out of the wellbore and replace the downhole tool or the failed sensor.

As described above, the trained backup sensor model(s) may be deployed uphole (e.g., in a surface computer) or downhole (e.g., in an MWD controller). In downhole deployments, the trained backup sensor model may be deployed, for example, in a printed wiring assembly (PWA) in an MWD controller or otherwise stored in downhole memory and may be executed using one or more downhole processors.

In a second example implementation, backup sensor data was synthesized for an annular (external) pressure sensor deployed in an MWD tool (an MWD tool in a CT deployment in this example). Since annular pressure gauge failures commonly result in a complete loss of data from the pressure gauge, model training did not inclu you you you de annular pressure, annular temperature, and any derived quantities such as a differential pressure and compensated WOB. In this example the extra trees algorithm provided the best performing model. The most important predictive channels were internal (pipe) pressure, uncompensated WOB, depth, time since the beginning of the run, and surface wellhead pressure. Overall, the generated a model sensor predicted the annular pressure with a mean absolute error (MAE) of 28 psi and a coefficient of determination (r-squared) of 0.98.

In a third example implementation, backup sensor data was synthesized for a pipe (internal) pressure sensor deployed in an MWD tool (an MWD tool in a CT deployment in this example). Since pipe pressure gauge failures commonly result in a complete loss of data from the pressure gauge, model training did not include pipe pressure, pipe temperature, and any derived quantities such as a differential pressure and compensated WOB. In this example the random forest algorithm provided the best performing model. The most important predictive channels were external (annular) pressure, depth, uncompensated WOB, circulation pressure, and surface wellhead pressure. Overall, the generated a model sensor predicted the annular pressure with a MAE of 22 psi and a coefficient of determination of 0.99.

In a fourth example implementation, backup sensor data was synthesized for WOB as determined in an MWD tool (an MWD tool in a CT deployment in this example). Since WOB failure commonly result in a complete loss of data from the strain gauge, model training did not include WOB and any derived quantities from input features. In this example the extra trees algorithm provided the best performing model. The most important predictive channels were external (annular) pressure, internal (pipe) pressure, differential pressure, telemetry voltage, and bit velocity. Overall, the generated a model sensor predicted the annular pressure with a MAE of 320 lbf and a coefficient of determination of 0.96.

It will be understood that the present disclosure includes numerous embodiments. These embodiments include, but are not limited to, the following embodiments.

In a first embodiment a method for synthesizing downhole sensor data while drilling a subterranean wellbore comprises training a deep learning model with historical drilling data to obtain a trained backup sensor model; deploying the trained backup sensor model at a drilling location; acquiring sensor measurements from a plurality of sensors while drilling the subterranean wellbore; and synthesizing a backup sensor measurement for at least one other sensor using the acquired sensor measurements and the trained backup sensor model.

A second embodiment may include the first embodiment, further comprising adjusting at least one drilling parameter while drilling the subterranean wellbore in response to the synthesized backup sensor measurement.

A third embodiment may include any one of the first through second embodiments, wherein the trained backup sensor model is deployed in a surface computer at the drilling location.

A fourth embodiment may include any one of the first through second embodiments, wherein the trained backup sensor model is deployed in a downhole tool deployed in the subterranean wellbore.

A fifth embodiment may include any one of the first through fourth embodiments, wherein the training the deep learning model comprises identifying relationships and/or correlations between sensor data obtained from different sensor channels in the historical drilling data.

A sixth embodiment may include any one of the first through fifth embodiments, wherein the deep learning model comprises a random forest model or an extra trees model.

A seventh embodiment may include any one of the first through sixth embodiments, further comprising retraining the trained backup sensor model using data obtained at the drilling location.

An eighth embodiment may include one of the first through seventh embodiments, further comprising computing an uncertainty of the synthesized backup sensor measurement.

A ninth embodiment may include any one of the first through eighth embodiments, further comprising evaluating at least one of a number of detected sensor failure modes, a comparison of uncertainty of the synthesized backup sensor measurements and an uncertainty of a corresponding sensor measurement, and a criticality of a failed sensor to drilling the subterranean wellbore.

A tenth embodiment may include the ninth embodiment, further comprising accepting the synthesized backup sensor measurements for use in the drilling operation when at least one of the following conditions is met: (i) the number of detected sensor failure modes is less than a threshold, (ii) the uncertainty of the synthesized backup sensor measurements is within a threshold of the uncertainty of a corresponding sensor measurement, and (iii) the criticality of the failed sensor is low.

In an eleventh embodiment a system for synthesizing downhole sensor data while drilling a subterranean wellbore comprises a downhole tool including a plurality of sensors; a trained backup sensor model deployed at a drilling location, the trained backup sensor model trained using historical drilling data; and a processor configured to acquire sensor measurements from the plurality of sensors in the downhole tool while drilling the subterranean wellbore; and synthesize a backup sensor measurement for at least one other sensor in the downhole tool using the acquired sensor measurements and the trained backup sensor model.

A twelfth embodiment may include the eleventh embodiment, wherein the processor is deployed at a surface location.

A thirteenth embodiment may include any one of the eleventh through twelfth embodiments, wherein the downhole tool is a measurement while drilling tool deployed in a coiled tubing string; and the trained backup sensor comprises at least one of an internal pressure sensor, an external pressure sensor, and a weight on bit sensor.

A fourteenth embodiment may include the eleventh embodiment, wherein the processor is deployed in the downhole tool; and the downhole tool comprises a measurement while drilling tool, a logging while drilling tool, or a rotary steerable tool.

A fifteenth embodiments may include the fourteenth embodiment, wherein the trained backup sensor comprises at least one of an internal pressure sensor, an external pressure sensor, and a weight on bit sensor when the downhole tool is a measurement while drilling tool or a rotary steerable tool; and the trained backup sensor comprises at least one of a resistivity sensor, a porosity sensor, a density sensor, or a gamma ray sensor when the downhole tool is a logging while drilling tool.

In a sixteenth embodiment a method for synthesizing measurement while drilling (MWD) sensor data while drilling a subterranean wellbore comprises training a deep learning model with historical drilling data to obtain a trained MWD backup sensor model; deploying the trained MWD backup sensor model at a drilling location; acquiring surface sensor measurements and downhole sensor measurements from a plurality of corresponding sensors while drilling the subterranean wellbore; and synthesizing a backup sensor measurement for at least one other MWD sensor using the acquired sensor measurements and the trained MWD backup sensor model.

A seventeenth embodiment may include the sixteenth embodiment wherein the at least one other MWD sensor comprises an internal pressure sensor, an external pressure sensor, or a weight on bit sensor. An eighteenth embodiment may include any one of the sixteenth through seventeenth embodiments, wherein the deep learning model comprises a random forest model or an extra trees model.

A nineteenth embodiment may include any one of the sixteenth through eighteenth embodiments, wherein the downhole sensor measurements are made using MWD sensors deployed in a coiled tubing string in use in a coiled tubing drilling operation.

A twentieth embodiment may include any one of the sixteenth through nineteenth embodiments, further comprising evaluating at least one of a number of detected sensor failure modes, a comparison of uncertainty of the synthesized backup sensor measurements and an uncertainty of a corresponding sensor measurement, and a criticality of a failed sensor to drilling the subterranean wellbore; and accepting the synthesized backup sensor measurements for use in the drilling operation when at least one of the following conditions is met: (i) the number of detected sensor failure modes is less than a threshold, (ii) the uncertainty of the synthesized backup sensor measurements is within a threshold of the uncertainty of a corresponding sensor measurement, and (iii) the criticality of the failed sensor is low.

Although artificial intelligence generated synthetic sensor data for drilling has been described in detail, it should be understood that various changes, substitutions and alternations can be made herein without departing from the spirit and scope of the disclosure as defined by the appended claims.

1. A method for synthesizing downhole sensor data while drilling a subterranean wellbore, the method comprising:
training a deep learning model with historical drilling data to obtain a trained backup sensor model;
deploying the trained backup sensor model at a drilling location;
acquiring sensor measurements from a plurality of sensors while drilling the subterranean wellbore; and
synthesizing a backup sensor measurement for at least one other sensor using the acquired sensor measurements and the trained backup sensor model.

2. The method of claim 1, further comprising:
adjusting at least one drilling parameter while drilling the subterranean wellbore in response to the synthesized backup sensor measurement.

3. The method of claim 1, wherein the trained backup sensor model is deployed in a surface computer at the drilling location.

4. The method of claim 1, wherein the trained backup sensor model is deployed in a downhole tool deployed in the subterranean wellbore.

5. The method of claim 1, wherein the training the deep learning model comprises identifying relationships and/or correlations between sensor data obtained from different sensor channels in the historical drilling data.

6. The method of claim 1, wherein the deep learning model comprises a random forest model or an extra trees model.

7. The method of claim 1, further comprising retraining the trained backup sensor model using data obtained at the drilling location.

8. The method of claim 1, further comprising computing an uncertainty of the synthesized backup sensor measurement.

9. The method of claim 1, further comprising evaluating at least one of a number of detected sensor failure modes, a comparison of uncertainty of the synthesized backup sensor measurements and an uncertainty of a corresponding sensor measurement, and a criticality of a failed sensor to drilling the subterranean wellbore.

10. The method of claim 9, further comprising accepting the synthesized backup sensor measurements for use in the drilling operation when at least one of the following conditions is met: (i) the number of detected sensor failure modes is less than a threshold, (ii) the uncertainty of the synthesized backup sensor measurements is within a threshold of the uncertainty of a corresponding sensor measurement, and (iii) the criticality of the failed sensor is low.

11. A system for synthesizing downhole sensor data while drilling a subterranean wellbore, the system comprising:
a downhole tool including a plurality of sensors;
a trained backup sensor model deployed at a drilling location, the trained backup sensor model trained using historical drilling data; and
a processor configured to:
acquire sensor measurements from the plurality of sensors in the downhole tool while drilling the subterranean wellbore; and
synthesize a backup sensor measurement for at least one other sensor in the downhole tool using the acquired sensor measurements and the trained backup sensor model.

12. The system of claim 11, wherein the processor is deployed at a surface location.

13. The system of claim 12, wherein:
the downhole tool is a measurement while drilling tool deployed in a coiled tubing string; and
the trained backup sensor comprises at least one of an internal pressure sensor, an external pressure sensor, and a weight on bit sensor.

14. The system of claim 11, wherein:
the processor is deployed in the downhole tool; and
the downhole tool comprises a measurement while drilling tool, a logging while drilling tool, or a rotary steerable tool.

15. The system of claim 14, wherein:
the trained backup sensor comprises at least one of an internal pressure sensor, an external pressure sensor, and a weight on bit sensor when the downhole tool is a measurement while drilling tool or a rotary steerable tool; and
the trained backup sensor comprises at least one of a resistivity sensor, a porosity sensor, a density sensor, or a gamma ray sensor when the downhole tool is a logging while drilling tool.

16. A method for synthesizing measurement while drilling (MWD) sensor data while drilling a subterranean wellbore, the method comprising:
training a deep learning model with historical drilling data to obtain a trained MWD backup sensor model;
deploying the trained MWD backup sensor model at a drilling location;
acquiring surface sensor measurements and downhole sensor measurements from a plurality of corresponding sensors while drilling the subterranean wellbore; and
synthesizing a backup sensor measurement for at least one other MWD sensor using the acquired sensor measurements and the trained MWD backup sensor model.

17. The method of claim 16, wherein the at least one other MWD sensor comprises an internal pressure sensor, an external pressure sensor, or a weight on bit sensor.

18. The method of claim 16, wherein the deep learning model comprises a random forest model or an extra trees model.

19. The method of claim 16, wherein the downhole sensor measurements are made using MWD sensors deployed in a coiled tubing string in use in a coiled tubing drilling operation.

20. The method of claim 16, further comprising:
evaluating at least one of a number of detected sensor failure modes, a comparison of uncertainty of the synthesized backup sensor measurements and an uncertainty of a corresponding sensor measurement, and a criticality of a failed sensor to drilling the subterranean wellbore; and
accepting the synthesized backup sensor measurements for use in the drilling operation when at least one of the following conditions is met: (i) the number of detected sensor failure modes is less than a threshold, (ii) the uncertainty of the synthesized backup sensor measurements is within a threshold of the uncertainty of a corresponding sensor measurement, and (iii) the criticality of the failed sensor is low.
